(19) United States
(12) Patent Application Publication
(10) Pub. No.: US 2013/0068395 A1
(43) Pub. Date: Mar. 21, 2013

(54) TYRE CAGE

(71) Applicant: David Norton-Smith, Duncraig (AU)

(72) Inventor: David Norton-Smith, Duncraig (AU)

(21) Appl. No.: 13/700,511

(22) PCT Filed: May 18, 2011
(86) PCT No.: PCT/AU11/00585

§ 371 Date: Nov. 28, 2012

(30) Foreign Application Priority Data
May 31, 2010 (AU) 2010902377

(51) Int. Cl. B60C 25/00

(52) U.S. Cl. 157/1

(57) ABSTRACT

A tyre cage 40 comprising a mounting member 42 and a plurality of arms 44, the mounting member 42 describes a plane and the arms have at least a portion of which extend away from that plane, whereby a tyre 24 may be at least partially enveloped by the mounting member 42 and arms 44 in combination.

### FIELD OF THE INVENTION

The present invention relates to a tyre cage. More particularly, the tyre cage of the present invention is intended for use in the safe inflation of tyres for use on heavy vehicles and machinery.

### BACKGROUND ART

The changing and inflating of tyres used on earth moving equipment/vehicles, and other heavy vehicles, is known to be a hazardous exercise, as is the operation of tyre handling machinery. A number of fatalities have been recorded in recent years in the Australasian region, together with a range of injuries and significant damage to equipment.

Existing tyre cages are generally fixed structures to which a tyre must be taken for inflation. These require the manual handling of tyres to insert them into the cage. Further, such cages typically only accommodate relatively small tyres, certainly smaller than might be found on large earth moving vehicles. Accordingly, dangerous practices are adopted in the inflation of large tyres, many of which involve operators standing in close proximity to a tyre undergoing inflation. As such, if a failure occurs in the bead of a tyre rim at high pressures and an operator is standing nearby, or perhaps even within the arms of a tyre handling machine, that operator may suffer serious injury and even death.

The present invention has as one object thereof to overcome substantially the abovementioned problems associated with the prior art, or to at least provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a tyre cage characterised in that it comprises a mounting member and a plurality of arms, the mounting member describes a plane and the arms have at least a portion of which extend away from that plane, whereby a tyre may be at least partially enveloped by the mounting member and arms in combination.

The mounting member preferably has provided thereon an attachment mechanism by which the tyre cage may be attached to a vehicle.

Preferably, the arms are adjustable such that the tyre cage may accommodate different sizes of tyre being enveloped thereby.

In one form of the invention an air pressure regulator may be provided on the tyre cage to aid in setting of correct tyre pressures.

In a further form of the present invention there are provided between 6 to 8 arms extending radially from the mounting member. Preferably, the portion of the arms extending away from the plane described generally by the mounting member extend at substantially right angles therefrom.

In accordance with the present invention there is provided a method for the inflation of a tyre, the method characterised by the method steps of first fitting a tyre to a vehicle or piece of machinery, positioning a tyre cage as described hereinabove about that tyre and subsequently inflating that tyre.

### BRIEF DESCRIPTION OF THE DRAWINGS

The tyre cage of the present invention will now be described, by way of example only, with reference to one embodiment thereof and the accompanying drawings, in which:

FIG. 1 is an upper perspective view of two prior art tyre cages;

FIG. 2 is a perspective view depicting the inflation of a tyre fitted to a heavy vehicle using prior art methods;

FIG. 3 is a first diagrammatic upper perspective representation of a tyre cage in accordance with the present invention, shown being held in position about a tyre by a vehicle;

FIG. 4 is a second diagrammatic upper perspective representation of a tyre cage in accordance with the present invention, shown being held in position about a tyre by a vehicle; and

FIG. 5 is a second diagrammatic upper perspective representation of a tyre cage in accordance with the present invention, shown being held in position about a tyre by a vehicle.

### BEST MODE(S) FOR CARRYING OUT THE INVENTION

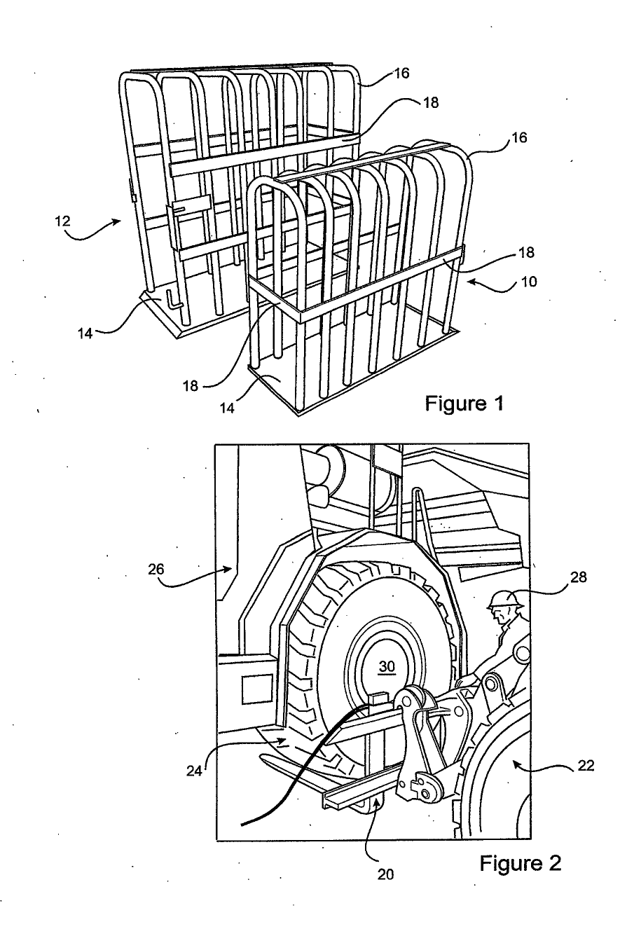

In FIG. 1 there are shown two prior art tyre cages 10 and 12. Each cage 10 and 12 comprises a base member 14 and a series of arched members 16 located thereon and which, with the base member 14, define a space into which a tyre to be inflated can be placed. One or more reinforcing members 18 are provided about the arched members and linking these together. The size of the space defined by the cages 10 and 12 can't be altered once constructed, so a number of such cages are required for varying sizes of tyres, and the tyre to be inflated must be manually handled into the cages 10 and 12.

In FIG. 2 there is shown a tyre handling attachment 20 provided on a front-end loader 22 (shown in part) and positioned against a large tyre 24 that has been fitted to the heavy vehicle 26 (again shown only in part). An operator 28 is shown standing nearby and overseeing the inflation of the tyre 24. It is possible that should a failure occur in a rim 30 to which the tyre 24 is fitted, or in the tyre itself, that the operator 28, because of his proximity to the tyre 24 and rim 30, may be injured or killed. This is the direct result of there being no protection for the operator 28 or anyone else nearby. Similarly, expensive equipment may also be damaged in this process.

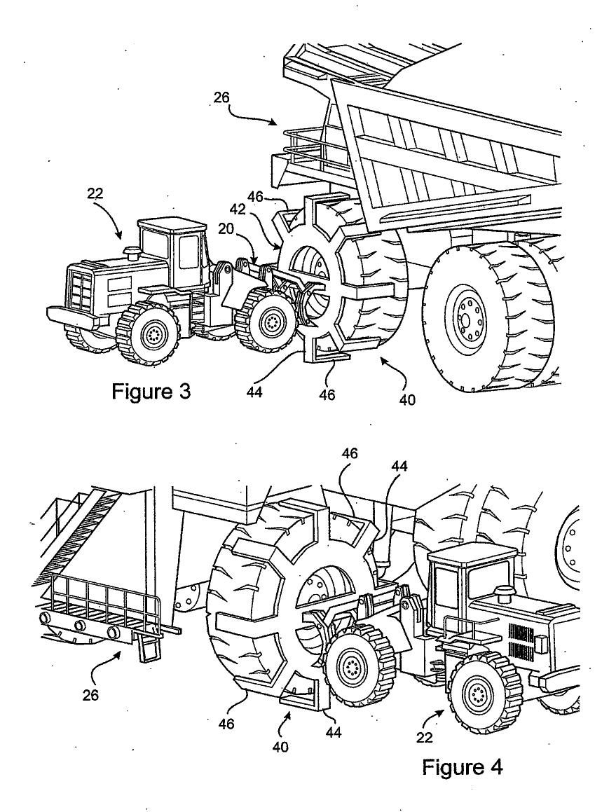

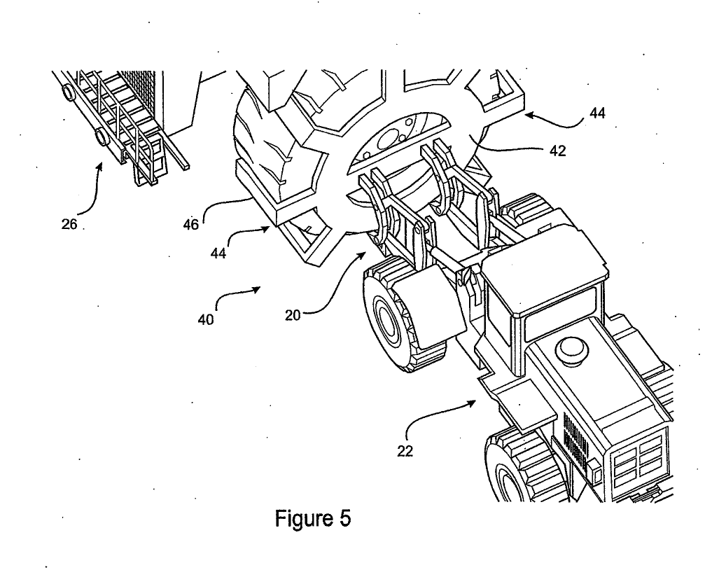

In FIGS. 3 to 5 there is shown a tyre cage 40 in accordance with the present invention. The tyre cage 40 comprises a mounting member 42 and a plurality of arms 44 that extend radially outwardly therefrom. The mounting member 42 is of generally circular and substantially flat form, thereby defining a general plane. The mounting member 42 is provided with appropriate fittings whereby it can be affixed, releasably, to the tyre handling attachment 20 of the front end loader 22.

The arms 44 are fixed to, or integrally formed with, the mounting member 42. However, it is envisaged that the length of the arms 44 may be adjustable. Providing the arms 44 with the ability to be adjusted for length will ensure that different size tyres 24 can be accommodated by the tyre cage 40 of the present invention.

The tyre cage 40 is provided with eight arms 44, as may be seen with reference to FIGS. 3 to 5. However, it is envisaged that this number may be varied whilst still obtaining the benefits of the present invention. For example, six arms 44 will be understood to reasonably achieve the objects of the invention.

The arms 44, or at least a proportion thereof, are provided with a terminal portion 46 that extends away from the plane generally described by the mounting member 42. In this manner, the tyre 24 may be at least partially enveloped by the mounting member 42 and arms 44 in combination.

It is envisaged that an air pressure regulator (not shown) may be provided on the tyre cage 40 to aid in setting of correct tyre pressures.

In use, the tyre 24 is first positioned on the vehicle 26 in known manner. The tyre cage 40 of the present invention may then be positioned by the front end loader 22 and attachment 20 such that the tyre cage 40 at least partially envelopes the tyre 24 (and rim 30). In this position the rim 30, a side wall of the tyre 24 and a portion of the surface of the tread portion of the tyre 24 is covered by the tyre cage 40. In particular, the rim 30 is covered by the mounting member 42. The generally circular arrangement of the mounting member 42 is arranged so as to be substantially adjacent the meeting of the rim 30 and the tyre 24 as it is here, at the bead, that many failures occur during inflation.

This arrangement, shown in FIGS. 3 to 5, allows the inflation of the tyre 24 without the level of exposure of the operator 28 to the dangers of a tyre 24 or rim 30 failure during inflation as is found with the prior art arrangement of FIG. 2. Further, the present invention 40 is envisaged to overcome substantially the disadvantages of the prior art cages 10 and 12 of FIG. 1, particularly with regard to the restriction in tyre size and the need to physically handle the tyre prior to inflation.

It is understood that, in addition to the front end loader 22, the tyre cage 40 of the present invention can be coupled to a variety of devices including but not limited to, an over-head crane, a fork lift and other tyre handling equipment.

Modifications and variations such as would be apparent to the skilled addressee are considered to fall within the scope of the present invention.

1. A tyre cage characterised in that it comprises a mounting member and a plurality of arms, the mounting member describes a plane and the arms have at least a portion of which extend away from that plane, the mounting member being proportioned to cover a bead of a tyre which is at least partially enveloped by the mounting member and arms in combination.

2. A tyre cage according to claim 1, wherein the mounting member has provided thereon an attachment mechanism by which the tyre cage may be attached to a vehicle.

3. A tyre cage according to claim 1, wherein the arms are adjustable such that the tyre cage may accommodate different sizes of tyre being enveloped thereby.

4. A tyre cage according to claim 1, wherein an air pressure regulator is provided on the tyre cage to aid in setting of correct tyre pressures.

5. A tyre cage according to claim 1, wherein there are provided between 6 to 8 arms extending radially from the mounting member, where the portion of the arms extending away from the plane described generally by the mounting member extend at substantially right angles therefrom.

6. A method for the inflation of a tyre comprising the steps of first fitting a tyre to a vehicle or piece of machinery, positioning a tyre cage about that tyre and subsequently inflating that tyre, wherein the tyre cage comprises a mounting member and a plurality of arms, the mounting member describes a plane and the arms have at least a portion of which extend away from that plane, the mounting member being proportioned to cover a bead of a tyre which is at least partially enveloped by the mounting member and arms in combination.

7. (canceled)

8. A method for the inflation of a tyre according to claim 6, wherein the mounting member is first attached to a vehicle by way of an attachment mechanism provided on the mounting member.

9. A method for the inflation of a tyre according to claim 6, wherein the arms are adjusted such that the tyre cage accommodates the size of tyre being enveloped thereby.

10. A method for the inflation of a tyre according to claim 6, wherein an air pressure regulator provided on the tyre cage is used to aid in setting of correct tyre pressures.

11. (canceled)

12. (canceled)
